(19) United States
(12) Patent Application Publication
(10) Pub. No.: US 2002/0043943 A1
(43) Pub. Date: Apr. 18, 2002

(54) LED array primary display light sources employing dynamically switchable bypass circuitry

(76) Inventors: Randy L. Menzer, Redmond, WA (US); Jacques M. Dulin, Morgan Hill, CA (US)

Correspondence Address: Jacques M. Dulin, Esq., Innovation Law Group, Ltd., Suite 101, 851 Fremont Ave., Los Altos, CA, 94024, US

(21) Appl. No.: 09/849,027

(22) Filed: May 4, 2001

Related U.S. Application Data
(60) Provisional application No. 60/239,415, filed on Oct. 10, 2000.

(51) Int. Cl. H05B 37/00

(52) U.S. Cl. 315/291; 315/185 R

(57) ABSTRACT

The invention comprises use of Dynamically Switchable Bypass (DSB) elements in association with one or more Light Emitting Diodes (LEDs) in arrays for illumination circuits to provide rugged, reliable lighting. The DSBs are selected from Transient Voltage Suppressors, including Silicon, Metal Oxide Varistors, and Multi Layer Varistors as well as Zener Diodes. The DSBs are not used as circuit protecting devices, but rather as alternative paths for electric current to bypass failed LEDs. Bi-directional TVSs are used as alternative electric paths for circuits using Alternating Current (AC) and parallel LED arrays that light on both phases of AC. Zener Diodes are used in parallel to, but in the opposite polarity orientation to, one or more LEDs in DC or rectified AC circuits. The inventive paired DSB/LED elements overcomes the black-out problems of prior series LED illumination systems, making possible the use of robust LEDs in illumination systems where reliability, long life, low power consumption, low heat output, resistance to shock, vibration, and humidity, and self-diagnosis are important. The DSB elements have breakdown voltages slightly higher than the LED(s) they support, so that when an LED fails, the conduction through the DSB begins. Because the conduction voltage of the DSB so nearly matches the conduction voltage of the LED(s), the remainder of the circuit continues to function as normal. The system is self-diagnostic in that any LED failure presents itself as a dark LED rather than as a whole string of dark LEDs. DSBs may be used with incandescent bulbs.

### RELATED APPLICATION

This application is related to, and claims priority of, Provisional Application Serial No. 60/239,414 filed Oct. 10, 2000 under 35 USC §119.

### FIELD OF THE INVENTION

The invention relates to illumination systems, and more particularly to the use of light elements, particularly Light Emitting Diodes (LEDs), in arrays in conjunction with Dynamically Switchable Bypass (DSB) circuitry to provide rugged reliability. The devices, circuits and systems of the invention show particular utility in aerospace, military, and commercial lighting applications or anywhere panel or display lighting is used.

### Background of the Art

The background of this invention involves both display light sources and dynamically switchable bypass circuitry.

Display Light Sources:

Display lighting, as distinct from general or area illumination including flood and spot lighting, are used for a variety of purposes including the illumination of panels, instrumentation, warning and directional signals, and the like. Currently available dedicated panel illumination systems generally use incandescent, electroluminescent (EL), or LED arrays to provide illumination.

A typical illumination system involves a circuit or system that provides electricity to the light element. Incandescent illumination systems have a relatively long life, but are sensitive to shocks and vibrations. Incandescent systems have substantial power requirements and accordingly create a great deal of heat for the light they produce. Another problem is that the copper leads on circuit boards must be sized appropriately for the power requirements of the circuit, which is several orders of magnitude greater than that of either EL or LED lighting.

Electroluminescent systems have short lives, and typically are susceptible to varying degrees of damage from humidity. However, they are rugged in terms of shock and vibration. These systems use a phosphor coating that emits light when electrically powered, functioning somewhat like capacitors. Because of the encapsulation of the phosphor and the nature of the phosphor, there are limits to the number of different colors produced. Further, EL displays experience rapid degradation of brightness over time, such that the “half-life”, i.e., the time for the initial brightness to decline to ½ the original, is on the order of 1000-3000 hours in typical avionics applications. Although several tricks are employed to extend the life of EL displays, each has its limitations. For example, although both reduction in voltage and in frequency of the AC current extends EL display life, the luminosity is significantly reduced, possibly to below required levels. Further, there is a power supply mismatch. That is, the voltage or frequency reductions necessary to achieve a satisfactory life do not match the supply, thus either preventing use of EL displays, or sacrificing life. For example, avionics are typically run at 110 volts/400 Hz. EL displays operated at those standard parameters have ¼ or less the half-life as compared to when run at 80 volts/256 Hz, but the latter do not match the power supply parameters. In order to run at the lower voltage and frequency, a separate power supply is required, adding cost to the system, and at the cost of lower luminosity. Stated another way, EL displays are very sensitive to significant drop-off in luminosity upon drop in frequency and voltage.

EL displays are typically designed with a relatively large area illuminated, as compared to point source illumination of incandescent and LED displays. The EL displays, being area illuminated, typically requires less balancing (thickness of paint on specific areas of the face plate) to provide uniform illumination, than incandescent or LED multi-point source displays. EL displays can have a single lead pair attached at one end of a relatively large area, yet the entire display surface will illuminate. This gives EL displays some advantage in shorter wiring leads. However, those apparent wiring and simpler balancing advantages of EL displays comes at the cost of EL display humidity sensitivity; the larger the surface area, the more humidity degradation sites can arise. Often the point of humidity attack is at the site of attachment of the lead, as secure attachment and good, vapor resistant electrical contact with the EL phosphor coating is problematic. Further, the humidity attack frequently leads to a speckled appearance of brownish or blackish (discolored) spots over large areas of the EL sheet surface, which may be a result of dielectric breakdown. This is in part a reflection that production processes must be carefully controlled and monitored in order to result in high quality, even illumination EL lamp sheet stock. Finally, the power required to operate an EL display varies by the area, so that the larger the panel being illuminated, the greater the power requirements.

In contrast, LED arrays are rugged systems that are not sensitive to shock, vibration, or humidity. As such, they have long service lives. Since LEDs are one-way diodes, their possible arrangements include parallel, series, or series-parallel for Direct Current (DC) systems. For Alternating Current (AC) systems, they may be connected in anti-parallel (opposed polarity pairs, or with the addition of a rectifier diode they may be connected in parallel, series, or series parallel. In a typical anti-parallel circuit configuration, Alternate lines are oriented appropriately to allow multiple LEDs to illuminate in both phases of the AC. In such a dual-string, oppositely oriented LEDs AC circuit, half of the LEDs will not illuminate with the failure of a single LED. In the rectified AC circuit, when one LED in a series of LEDs fails, the entire series or string of LEDs fails. Therefore, while LEDs are rugged and seem ideal for illumination, LEDs traditionally do not make good illumination systems for panels, warning lights, etc. when several LEDs are in series, because they do not provide illumination in their failure mode. This makes it time consuming to determine which of the LEDs in the failed string has failed, since all black out when only one goes bad.

Dynamically Switchable Bypass Circuits:

Among the various types of Dynamically Switchable Bypass devices (herein DSBs) are included: a) unidirectional devices that do not conduct until presented with a voltage greater than their turn on threshold, such as Zener Diodes; b) bi-directional devices that conduct in either direction when the circuit voltage exceeds their threshold voltage, such as Transient Voltage Suppressors (TVSs); and c) bi-directional Metal Oxide Varistors (MOVs) and bi-directional Multi-Layer Varistors (MLVs) that change from a high resistance state to a low resistance state once the circuit voltage exceeds their clamping voltage.

MLVs, MOVs, and TVSs are commonly used in parallel with circuit loads to protect circuits from damage due to voltage spikes. In conventional circuit architecture, DSBs reduce spikes to safe levels by clamping voltages to predetermined, acceptable levels. Only after a voltage spike exceeds the voltage threshold does the MLV, MOV, or TVS shunt the current so that the circuit continues to receive the safe, clamped voltage. The clamp ends once the voltage drops below the threshold. MLVs are extremely small devices, have small power dissipation capabilities, and thus commonly provide static protection in low voltage circuits. MLVs can handle many spike events during their service life. Typical circuits utilize MOVs not only to protect electronics from transient electro-static discharges, but also from much larger transient spikes, such as those caused by lightening strikes. The MOVs, however, can suppress only a limited number of spikes before failing. Silicon TVSs are similar to MOVs, though silicon TVSs clamp faster than MOVs and at lower voltages, but are limited in their surge current levels. Silicon TVSs have a service life capable of handling a much larger number of spike events than MOVs.

Accordingly, there is a need in the art for illumination systems, particularly those used in critical safety applications subject to high vibration, shock, and humidity (such as aircraft panels), which have long lives and are not subject to the shortcomings of the present incandescent, EL, and LED systems.

### THE INVENTION

### Summary, Including Objects and Advantages

The invention comprises a circuit design and system that makes possible the use of robust light element arrays in a wide variety of illumination systems where reliability over a long use life, low power consumption, low heat output, resistance to shock, vibration and humidity, and easy burn-out element replacement are important. More particularly, and in the preferred embodiment, the invention comprises the use of one or more DSB devices in parallel to one or more LED light elements to keep the circuits functioning when an LED fails, and to assist in pinpointing which of the LEDs in a string have failed without extensive diagnostic testing or a pull-and-replace empirical repair procedure. While the DSB bypass architecture of the present invention is applicable to both incandescent and LED light elements, the LED/DSB architecture will be discussed in detail by way of illustration of the principles of the invention.

The inventive circuit design employs DSB devices, not as circuit protecting devices, but rather as alternative paths for electric current to bypass failed LEDs in the circuit. DSB devices include voltage and current activated bypass devices, such as MLVs, MOVs, TVSs, and Zener Diodes, as well as present and future devices triggered by voltage or current changes, magnetic fields, optical changes, or some combination thereof. The inventive paired, parallel, opposed polarity DSB/LED circuit design permits conduction around circuit breaks due to any failed LED. The DSB is “matched” to the LED, by which is meant that the breakdown voltage is just above the forward voltage range of the LED. A DSB device that has a breakdown voltage slightly higher than the LED it supports, wired in opposed polarity parallel to the LED, permits conduction to begin at a voltage just above the typical forward voltage of the LED. An example is the use of a Zener diode DSB having a conduction voltage of 3.9 volts wired in parallel to an LED having an operating voltage of 3.3 volts. Because the DSB conduction voltage so nearly matches the nominal conduction voltage of the LED, in the event of an open LED, current bypasses the failed LED through the DSB device, permitting the rest of the non-failed LEDs in the illumination circuit to function normally, i.e., to light or remain lit. Stated another way, the remaining LEDs cannot distinguish the difference between the LED(s) and the DSB device. This means that in a string, when an LED fails, it is easily detectable as it alone goes dark, and identifying the LED that failed, is instantaneous. Extensive diagnostics or time consuming repetitive remove and replace testing is not required.

The inventive system applies to AC, rectified AC, and DC circuits alike. The inventive circuit can include LEDs in one or more series strings, multiple LEDs or LED strings in parallel, or series of LED sets wired in parallel, typically in opposed polarity sets, or any combination of parallel and/or series wired LEDs. In each case, the inventive circuit involves the use, in combination, of one or more appropriate DSB device(s) associated in parallel with one or more LEDs, the DSB device(s) being oriented and located in the circuit with respect to the LEDs so that in the event an associated LED fails, current can pass through the DSB to complete the circuit. This thereby permits the remaining LEDs to remain lit, with “lit” meaning the LED remains ON or can continue to be turned ON and off after the failure of another LED in the array. The term “array” herein means any arrangement of at least two LEDs for a particular illumination application, whether in one or more regularly-spaced or irregularly-spaced strings, or in a geometric or empirically placed “best practical location” arrangement.

In AC circuits, the DSB device used should be bi-directional to ensure operation in both phases of AC. In DC or rectified AC circuits, the DSB devices can be unidirectional. A principal advantage of this invention is that the DSB/LED circuits are rugged, less susceptible to damage, output less heat and use less power than incandescent, provide nearly full LED lighting in the event of failure of an LED in the array, and are self-diagnostic. Further, the power required to operate an exemplary array of 2 strings of 9-11 LED/DSBs for illuminating a panel is on the order of the same or less than the power to illuminate an EL display of the same size and equivalent turn-on threshold voltage, by way of example, 6-10 mA for the inventive display vs 20 mA for the equivalent EL display. The inventive circuit using LED/DSB device pairs thus solves the inherent weaknesses of incandescent, electroluminescent, and conventional LED illumination systems.

The invention also includes new integrated light elements comprising the LED element integrated in parallel with a DSB element arranged in opposed polarity to the LED, preferably with a single pair of circuit connection leads. The inventive design, using DSBs in conjunction with LEDs, lends itself to creating new LEDs that contain DSBs within their circuitry. With the appropriate DSB selected, the inventive integrated LEDs have a failure mode that surpasses that of other light sources. The integrated LED/DSB, upon failure of the LED, passes current through the DSB to keep the remaining LEDs in the string functioning.

In a further embodiment, the inventive failed-LED-bypass design may incorporate a second LED, wired in series to the parallel DSB. This is termed the “dual” or “PS LED/DSB-LED” configuration, which provides, upon failure of the primary LED, a secondary LED light source in close association with the primary LED. This redundant system is for illumination safety in selected critical applications; such a dual LED system continues to provide illumination where all other light systems would fail to do so. Where specifications permit, for diagnostic or alert purposes, a circuit employing the redundant or dual LEDs could selectively employ primary and secondary LEDs of different colors, intensity, or other such differences so that the failure of the primary LED is readily perceived.

The inventive integrated or dual DSB/LED devices are preferably integrated in side-by-side or back-to-back arrangement, and where desired, can be integrated within one plastic shell or bezel, such as within the plastic bead, face cover, or shell of a conventional LED, or the devices can be clustered or co-located in close proximity to one another.

One of the most serious limitations of currently available EL and incandescent display illumination sources is that as systems, they are not as rugged as LEDs. For incandescent lighting, high power consumption, shock and vibration susceptibility are principal drawbacks. For EL systems humidity and rapid drop in brightness/short life are principal drawbacks. In contrast, LEDs themselves are far less susceptible to shock, vibration, or humidity and they do not create problems associated with the heat of incandescent lighting. However, currently available LED illumination systems, when configured with two or more LEDs in series, lack a reasonable failure mode, being subject to total blackout if only one LED fails. Thus, each of these systems currently in use has some serious inherent weakness that limits its utility. A principal advantage of the inventive circuit is that it preserves the inherent ruggedness of the LED illumination systems, avoids the necessity for complex, redundant wiring, and, in a simple and inexpensive manner, avoids total blackout when only one LED in a string or array fails.

Another limitation of currently available illumination systems is that when a single illumination source, e.g., an incandescent bulb or an LED, fails in a circuit, where the illumination sources are wired in series, all the illumination sources fail. Diagnosis of the entire system is required in order to determine which light source failed so that the circuit can be repaired. In other words, when one of the lights fails in a conventional series-wired system, all of the lights in the circuit go dark and there is no simple way to determine which light caused the panel failure. To avoid this problem, some present circuits wire the illumination sources to the power source in parallel. Because such a circuit requires wiring each light source from its location to the power source, the wiring needed can increase exponentially over the wiring needed for a series system.

A further advantage of the inventive illumination system is that LEDs have very low power requirements and produce very little heat, relative to the quantity of light they emit. For that reason, circuits designed for LEDs can use less expensive, lighter weight, and less heat resistant wires and components. In applications where temperature is important, like in aviation panel-display lighting, this means that inventive panel displays will not become too hot to touch.

Accordingly, the advantages of the inventive LED display systems include:

Luminosity is essentially frequency independent as compared to ELs, which dim significantly over time with use.

Voltage turn on threshold of a wide variety of different sized display panels having a wide range of numbers of LEDs, e.g., from 5 or less to over 20 LEDs in the panel strings, can easily be balanced by use of more or less LED's in strings, or a TVS or Zener diode in series in the string to balance the turn on voltage in all panels or among strings of differing length in the same panel, so the same level of dimming is achieved uniformly by a master cockpit panel dimmer;

Significantly longer life as compared to EL's, typically many orders of magnitude longer; for example, in comparative testing, a conventional green EL is down to 93% brightness after around 40 hours continuous use while comparable white LED is still 93% after 9000 hours continuous burn;

Very high humidity resistance, which can be ensured by appropriate LED and circuit encapsulation;

Low power consumption ranging from equivalent to Els to less than 50% of EL displays of the same size panels; depending on design factors & luminous efficiency of the particular LEDs chosen;

No blackout on failure of any one or more LED in the string due to use of the paired, parallel DSB architecture;

Use of single, integrated LED/USB device;

Simplified, standard use of white LED's with any color of filter in the face plate recesses as dictated by use or desired by customer; and

Redundancy architecture feasible with dual device (PS LED/DSB-LED) architecture.

The scope of application of the inventive circuit system is broad, as a number of alternative circuit architectures will suggest themselves to those skilled in the art as suitable for a wide variety of illumination applications. These applications include panel displays, edge lit cellular telephone displays, warning and alarm lights, vehicular stop and warning lights, watches, clocks, architectural, directional, identification, and exit/entrance signage, advertising displays and signs, and artistic works, to name a few.

### BRIEF DESCRIPTION OF THE DRAWINGS

The accompanying drawings are incorporated in, and constitute a part of, this specification and illustrate one or more exemplary non-limiting embodiments of the invention, which, together with the description, serves to illustrate applications of the principles of the invention. In the drawings:

FIG. 1 shows a circuit diagram of a non-rectified opposed polarity-pairs circuit along the lines of a known series, anti-parallel LED drive circuit;

FIG. 2 shows a first embodiment of the inventive circuit, employing parallel DSB/LED geometry wiring multiple (4) sets of parallel wired opposed polarity LEDs in series;

FIG. 3 shows a single string LED rectified AC circuit (also exemplary of a DC circuit), but not employing the inventive DSB architecture;

FIG. 4 shows a second embodiment of the inventive circuitry in which the DSB device is a Zener Diode across each LED in a single series wired string;

FIG. 5 shows a third embodiment of the inventive circuitry, a multiple string rectified AC circuit, employing the inventive DSB/LED arrangement, in this case use of a Zener Diode across each LED;

FIGS. 6A and 6B show an exemplary panel display employing the inventive DSB/LED circuitry shown in FIG. 5, with FIG. 6A showing the faceplate (or lightplate) of the panel display, and FIG. 6B showing the inventive FIG. 5 circuitry implemented on a circuit board;

FIGS. 7A, 7B, and 7C are a related series, showing first the circuit board of FIG. 6B, then an enlarged section of that circuit board in FIG. 7B, and finally a cross-sectional slice of FIG. 7B taken along the line 7-7 is shown in FIG. 7C;

FIG. 8 shows a redundancy architecture comprising a dual PS LED/DSB-LED arrangement wherein a primary LED is in parallel to a series consisting of a DSB and a secondary LED;

FIG. 9 shows an integrated DSB/LED arrangement with a DSB associated with an LED and showing an optional bezel;

FIGS. 10A and 10B show two alternative architectures for an integrated dual DSB/LED of the type in FIG. 9 within a single LED bezel, FIG. 10A showing a side by side bezel, and FIG. 10B showing an annulus/core bezel arrangement, with the LEDs and/or bezels optionally being of different colors;

FIG. 11 illustrates the technique for balancing turn-on voltage threshold for two different sized panels having two different LED/DSB string lengths, so that common voltage dimming device can dim both panels equally and simultaneously; and

FIG. 12 is a graph of luminosity life of comparable green EL and green LED panels in terms of % Brightness vs Time, showing that luminosity loss over time of the LED is only a fraction of that of the EL.

### DETAILED DESCRIPTION, INCLUDING THE BEST MODES OF CARRYING OUT THE INVENTION

The following detailed description illustrates the invention by way of example, not by way of limitation of the principles of the invention. This description will clearly enable one skilled in the art to make and use the invention, and describes several embodiments, adaptations, variations, alternatives, and uses of the invention, including what are presently believed to be the best modes of carrying out the invention.

In this regard, the invention is illustrated in the several figures and tables, where applicable, and is of sufficient complexity that the many parts, interrelationships, process steps, and sub-combinations thereof simply cannot be fully illustrated in a single patent-type drawing or table. For clarity and conciseness, several of the schematic diagrams omit parts or steps that are not essential in that drawing to a description of a particular feature, aspect or principle of the invention being disclosed.

Each of the circuit diagrams included is merely exemplary of a typical circuit and as such, the specific placement of the LED or incandescent light elements (exemplified throughout as LEDs), resistors, and other circuit elements, is not essential. Thus, one drawing may show the best mode embodiment of one feature, and another drawing will call out the best mode of another feature. Process aspects of the invention are described by reference to one or more examples or test runs, which are merely exemplary of the many variations and parameters of operation under the principles of the invention.

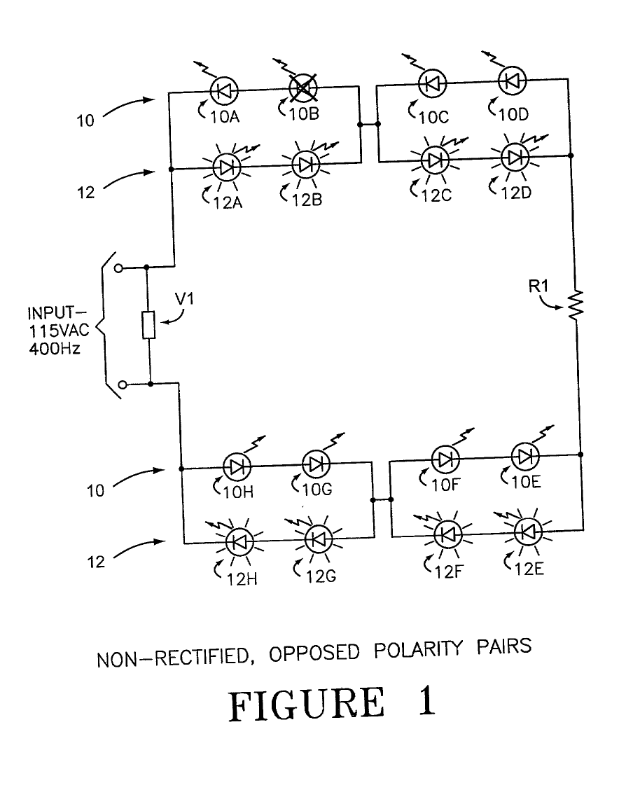

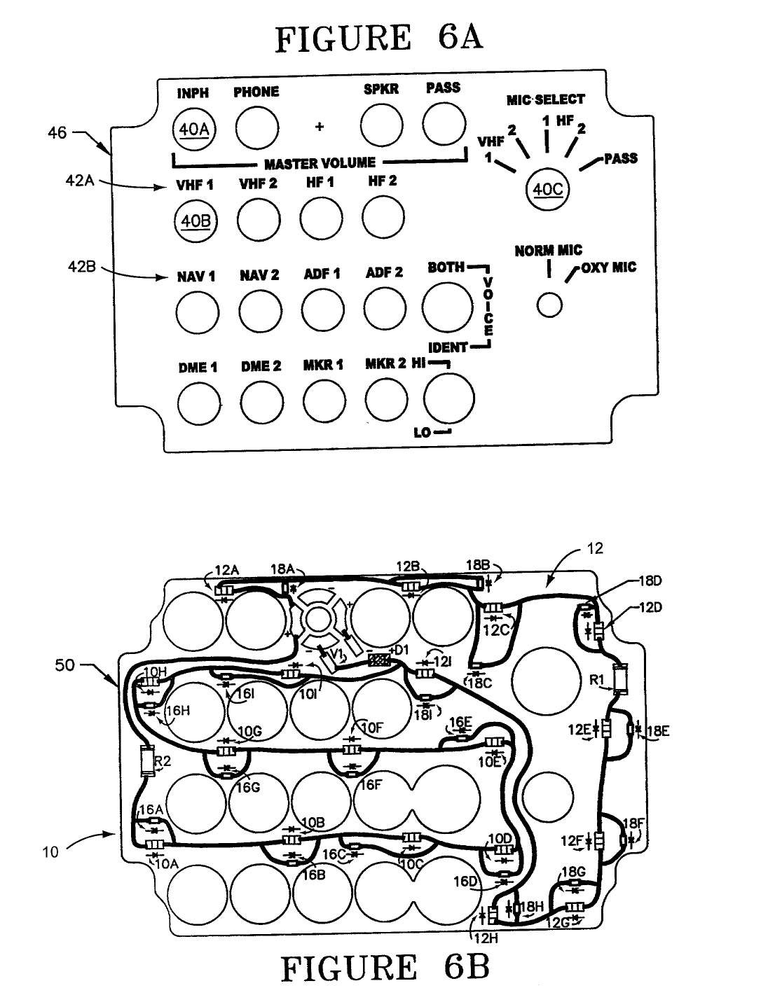

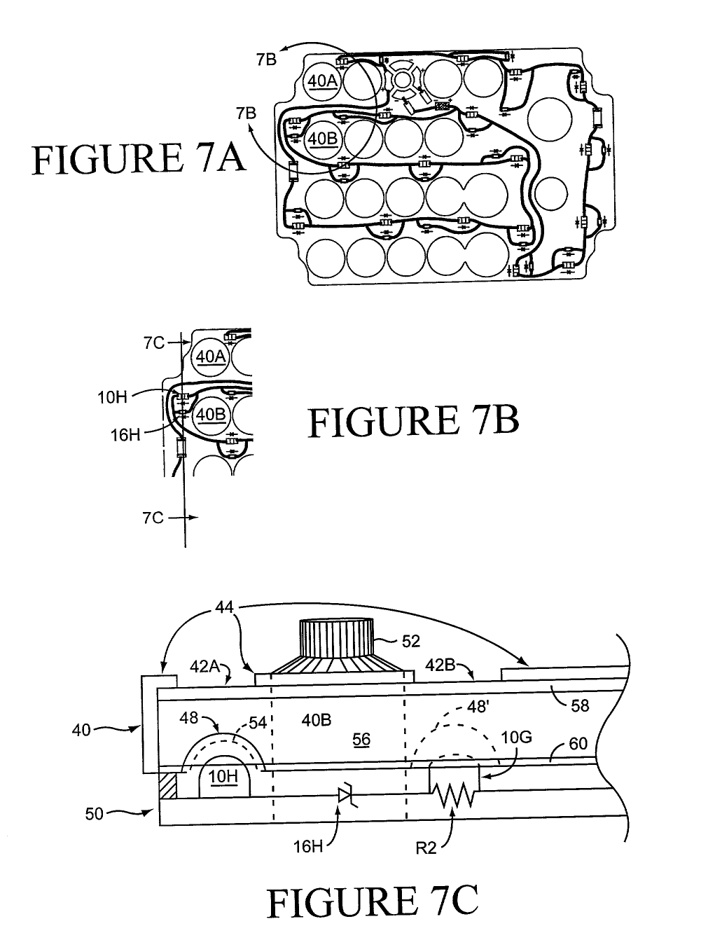

In FIGS. 6B, 7A and 7B, the convention used is that heavy solid lines represent the circuit leads. In FIGS. 1-5, a jagged arrow is used as a depiction that the adjacent element is a light emitting diode (LED). LEDs drawn with a sunburst (small lines radiating outwards every 45 degrees drawn around the LED) signify LEDs that emit light, while LEDs that do not have such a sunburst cannot light (and are dark). Any LED drawn with a large “X” through it is a failed LED that is no longer capable of passing current or emitting light.

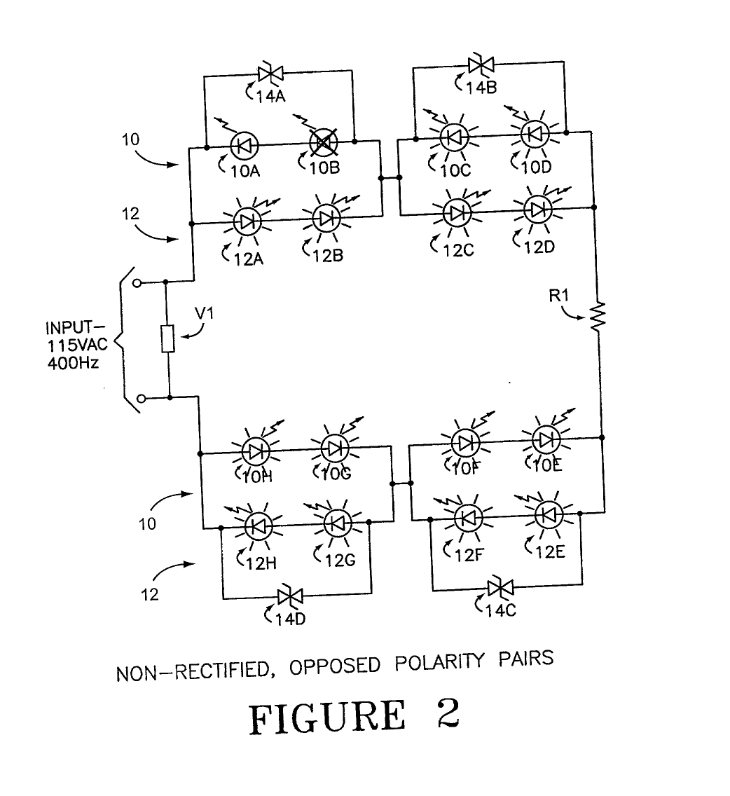

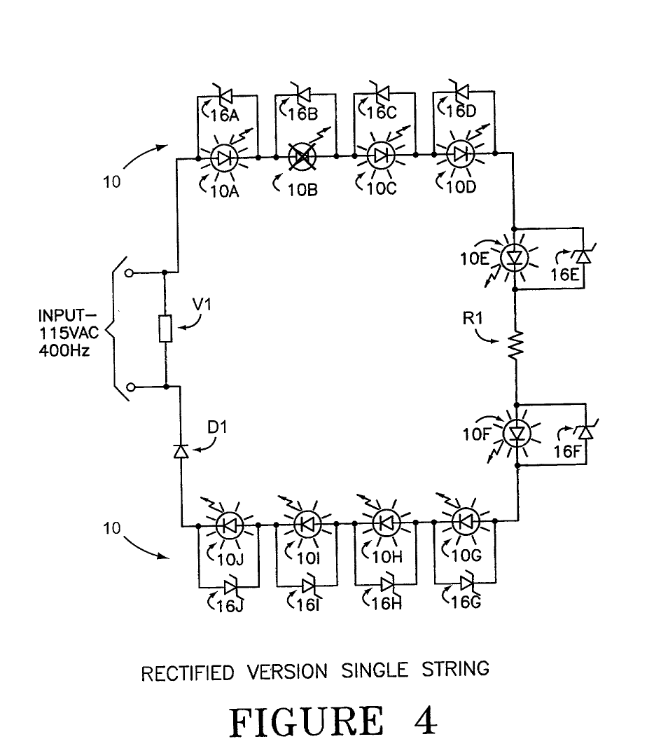

FIG. 1 shows a non-rectified, opposed-polarity-pairs circuit, which is an extension of a shorter, 4-LED series, anti-parallel LED 14 V, 400 Hz standard aircraft AC power drive circuit proposed by HP (and thus represents an application of a known design, the principle of which is prior art). This circuit comprises sets of opposed polarity pairs of LEDs wired in parallel, with the sets, in turn, wired in series. The circuit comprises, inter alia, an AC input and one or more LEDs in series, parallel, or series/parallel circuits, the latter shown here. In order to protect the circuit from over-voltage spikes, the circuit can employ a circuit protection device in the usual orientation, here, a Varistor, V1, bridging the AC terminals as shown. To increase the turn-on voltage of the non-rectified, opposed-polarity-pairs circuit, the circuit can include an additional TVS or Zener Diode in series with the LED sets (as shown in more detail in FIG. 11 to balance the turn-on voltage of different length strings). To limit the current through the circuit, the circuit can use resistors as required (here, resistor R1). In the examples described and illustrated in FIGS. 1-7C herein: the LEDs are Nichia NSCW100 or equivalent; the resistors R1 and R2 have the approximate value of 10 k Ohms at 1 Watt; the varistor V1 is typically V 200 Ch8 or the like; the rectifier diode D1 is a 1N4007 or equivalent; the TVS-type DSBs (e.g., as in FIGS. 2 and 8-10B) may be SMBJ 6.5CA or similar; and the Zener diode-type DSBs (e.g., as in FIGS. 4, 5, 6B, 7A-7C, 8-10B and 11) may be BZT52-C3V9DICT or similar; where the circuit input is 115 V AC, 400 Hz aircraft power. Of course, based on the principles of the invention as disclosed herein, one skilled in the art can select appropriate types, values and numbers of the required components to provide an appropriate turn-on threshold, voltage drop, current and power input for a particular illumination usage.

In FIG. 1, the LEDs are arranged in four parallel wired groups or sets, each set comprising 2 LEDs in series labeled 10A, 10B in a first branch, and 2 LEDs in series labeled 12A, 12B in a second branch, each set having two pairs of 2 LEDs in “anti-parallel” orientation. The diagram demonstrates that a failure of LED 10B, as signified by the “X” through it, results in a blackout of all other LEDs in that polarity orientation, that is, LEDs 10A-10H. The LEDs not in the same polarity orientation as 10B continue to emit light (LEDs 12A-12H). However, because all the LEDs in the 10A-10H string go dark, it is not possible to ascertain, without testing, which one of 10A-10H actually failed. That is, this circuit is not self-diagnostic.

FIG. 2 shows an embodiment of the inventive circuitry having the same LED arrangement as in FIG. 1, additionally employing the inventive use of DSB devices disposed in parallel to each of the polarity orientation branches 10 and 12 of each LED set. The circuit of FIG. 2 employs a bi-directional TVS across each opposed-polarity pair of LEDs (TVSs 14A-14D). For simplicity, the DSB branch is shown above the 10 branch but it should be understood that it could be located anywhere it can bridge the LEDs of the group, e.g. below the 12 string or medial to the 10 and 12 branches. The TVS provides a shunt path for current to flow around an open LED to the remainder of the LEDs in that polarity branch. This is illustrated by the failure of LED 10B resulting in a blackout of LEDs 10A and 10B only.

In this example, the TVS can have a breakdown voltage of approximately 7.2 to 9.1 volts which allows conduction just beyond the typical forward voltage of 2 LEDs in series, in this case, two 3.5 volt LEDs (10A and 10B). Because the conduction voltage of the TVS so nearly matches the nominal conduction voltage of the series LEDs, the rest of the illumination circuit cannot distinguish the difference, and LEDs 10C-10H remain lit.

In the inventive embodiment in FIG. 2, when an LED fails, such as when 10B fails, only two LEDs go dark. The rest of the LEDs in the circuit continue to light, as normal. Unlike in the conventional circuit of FIG. 1, in the event of a failed LED, the inventive circuit (FIG. 2) is self-diagnostic. By simply looking at the circuit with any faceplates or other covers removed, it can easily be determined which LED has failed. In this case, the self-diagnostic aspect of the inventive circuit results in only two non-lit LEDs and their replacement would involve far less time and diagnostics than in the conventional circuit, where all of the LEDs in a string fail to light.

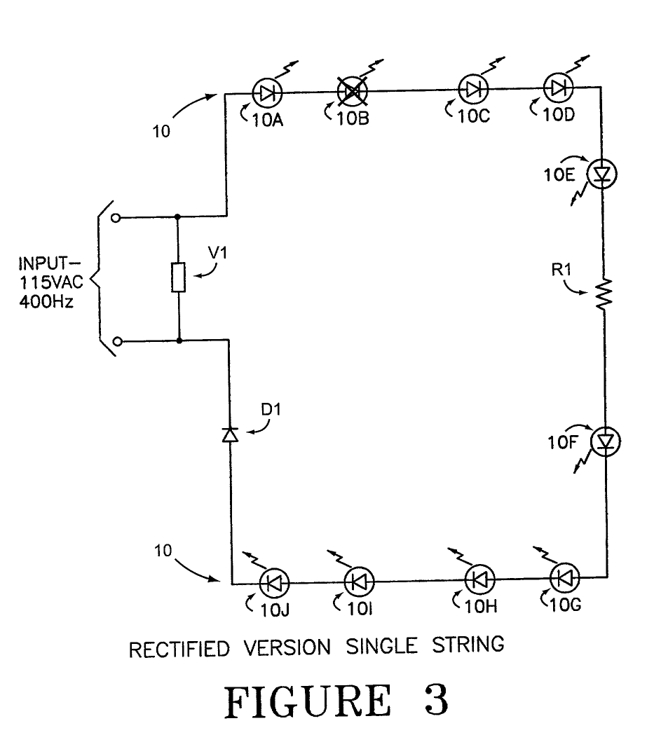

FIG. 3 shows a rectified AC circuit with a single string of LEDs in series, but without the use of the DSB architecture of the invention. The circuit comprises an AC input across a Varistor V1, ten LEDs labeled 10A-10J in series, a suitable resistor R1 to limit the circuit current, and a rectifier diode (D1) to rectify the current. The circuit of FIG. 3 is also typical of DC circuits, though such a DC circuit would employ a DC power source and would not use diode D1. As is possible with a TVS in the circuits of FIGS. 1 and 2, the DC or rectified AC circuits may employ a Zener diode or TVS in series in the circuit to increase turn-on threshold. In FIG. 3, the failure of LED 10B results in the blackout of all other LEDs (10A and 10C-10J). To determine which LED failed would require extensive diagnostics, as the entire circuit would be dark.

FIG. 4 shows an embodiment of the inventive circuitry having the same LED arrangement as in FIG. 3, additionally employing the inventive DSB devices wired in parallel with each LED of the circuit. The DSBs are in opposed polarity orientation, as shown, which may also be termed an “anti-parallel” circuit orientation. In this case, by adding Zener Diodes (16A-16J) in anti-parallel configuration to each LED (10A-10J), if an LED fails (as LED 10B has failed), the voltage at Zener Diode 16B exceeds the breakdown voltage and current will pass through Zener Diode 16B. Because the Zener Diode creates a voltage drop of approximately 3.9 volts, conduction through the diode will nearly match the nominal conduction across a single LED (e.g., 3.3 volts) and the rest of the illumination circuit cannot distinguish the difference, thus LEDs 10A and 10C-10J remain lit.

In the inventive embodiment of FIG. 4, when an LED fails, such as when 10B fails, only the single, failed LED goes dark. The rest of the LEDs in the circuit continue to light, as normal. Unlike in the conventional circuit of FIG. 3, in the event of a failed LED, the inventive circuit (FIG. 4) is self-diagnostic. By simply looking at the circuit with any faceplates or other covers removed (and in some cases without the faceplate removed), which LED has failed can be easily determined. In this case, the self-diagnostic inventive circuit will have only one non-lit LED, the failed LED. Equally important is the fact that where the circuit string is on a base plate of an illuminated display having a diffuser plate, the loss of but one or two LED's out of the ten in the string does not result in the entire display going dark. The diffuser plate continues to spread the light of the remaining LEDs throughout the plate, resulting in the indicia on the face of the display to remain lit and readable. Indeed, with the LEDs strategically placed, significant loss of illumination to the point of non-readability may not occur until more than half the LEDs are out. Before that point, the loss is noticeable, so that servicing can be scheduled, but the display panel, or the unit to which it is attached, need not be taken out of service until convenient. That is, loss of a single LED does not create a “black-out, immediate service required” condition, which is a significant advantage for service scheduling.

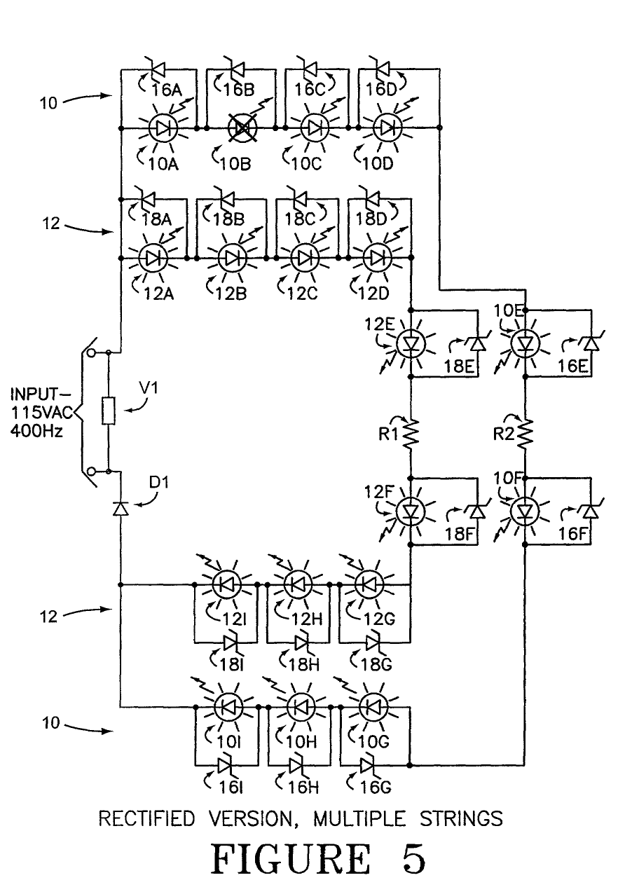

FIG. 5 shows another embodiment of the inventive circuit pairing each LED with a DSB in parallel, and the DSB/LED sets wired in multiple parallel strings of series of sets (here two strings) in a rectified AC circuit. This circuit comprises an AC input across a Varistor V1, a rectifier diode D1, two resistors R1 and R2, and two parallel strings of DSB/LED pairs (LEDs 10A-10J paired with Zener Diodes 16A-16J, and LEDs 12A-12J paired with Zener Diodes 18A-18J, respectively). In this diagram, the failure of LED 10B, rather than causing a blackout of the entire 10A-10J strand, causes no further interruption because the current passes through Zener Diode 16B. As in FIGS. 2 and 4, in the event of an LED failure, the circuit is self-diagnostic, in that only the failed LED goes dark (10B). Diagnosis of the failure involves simply finding the dark LED.

FIG. 6A shows the user-viewable faceplate of an exemplary panel display employing the inventive DSB/LED circuitry of FIG. 5. FIG. 6A includes various indicia (letters and shapes) etched into, or painted onto (including reversed-out), the faceplate, exemplary ones of which the labels 42A and 42B identify. In addition, the panel assembly of FIG. 6A has several through-holes through which switches, buttons, or knobs may protrude; exemplary ones are marked 40A-40C.

FIG. 6B is a base plate (or Circuit Card Assembly) lying behind (beneath) the faceplate of FIG. 6A. This base plate has a circuit similar to that of FIG. 5, that is, a rectified AC circuit with two strings 10 and 12 of anti-parallel LEDs and Zener Diodes, with the LEDs of the first string 10 labeled 10A-10I being coupled with Zener Diodes 16A-16I, and LEDs of the second string 12 labeled 12A-12I being coupled with Zener Diodes 18A-18I. The circuit also shows the AC input across Varistor V1 (which in this case would be an MOV), a rectifying diode D1, and the two resistors R1 and R2.

FIGS. 7A, 7B, and 7C illustrate a progressively enlarged and sectional view of the panel of FIG. 6A and the circuit board of FIG. 6B as they are assembled, and the location of that view with respect to the circuit board. FIG. 7A is a reduced, simplified view of FIG. 6B, with the area that is to be viewed identified by the partial circle labeled 7B-7B. FIG. 7B is a top plan view of the enlarged section of FIG. 7A showing that the section view is taken along line 7C-7C. FIG. 7C is the side section view of the inventive circuitry of FIGS. 6B, 7A, and 7B, mounted on a base plate circuit board 50. Consistent with the labels in FIG. 6B, the sectional view shows LED 10H, its associated Zener Diode 16H, resistor R2, and a knob 52. The knob at 52 is exemplary only, and the device with which the panel display is associated could call for a toggle switch, a push button, or any other physical object that would protrude through the circuit board.

Also shown in FIG. 7C is an LED (10G) in the background. Spaced above the circuit board (50) is the faceplate (46) of FIG. 6A. The faceplate comprises a sheet of transparent or translucent plastic 56, coated on both faces with white plastic sheet or paint 58, 60. The top is overcoated with an opaque coating, typically black or gray paint 44. Formed in the back (the underside) of faceplate 46 are recesses 48 and 48′, which extend into the face plate to permit light from the LEDs to enter the plate and spread laterally throughout the plate, thereby diffusing and evening the illumination by the LEDs therebelow. The diffusion function may be in a separate diffuser plate. Where the LEDs include a bezel, or a filter, these recesses 48 provide space for the LED bezels or color filter inserts. The recess 48 is shown by way of example as a rounded-edged recess, although in practice, the shape could be squared-edged or another shape, as determined by the device design. The inside edge of recess 48 and 48′ optionally can receive a colored plastic insert, e.g., a color filter (54), to select the color of light that passes into the face/diffuser plate to be displayed in the letters or zones 42A and 42B that are etched out of the topcoat 44, as seen in FIG. 6A. As seen in FIG. 7C, the light dispersed throughout the faceplate 56 backlights the areas 42A, 42B with the color of the light from the LEDs and the filters. These areas and letterings identifying the switches on the display are etched out of the coating 44, and are clearly and crisply readable as the rest of the cover does not transmit light due to the highly opaque coating 44, typically black, gray, or another such opaque color paint. The FIGS. 7A-7C also show the various holes in the panel display corresponding to those seen in FIGS. 6A-6B and 7A-7C, such as 40A and 40B.

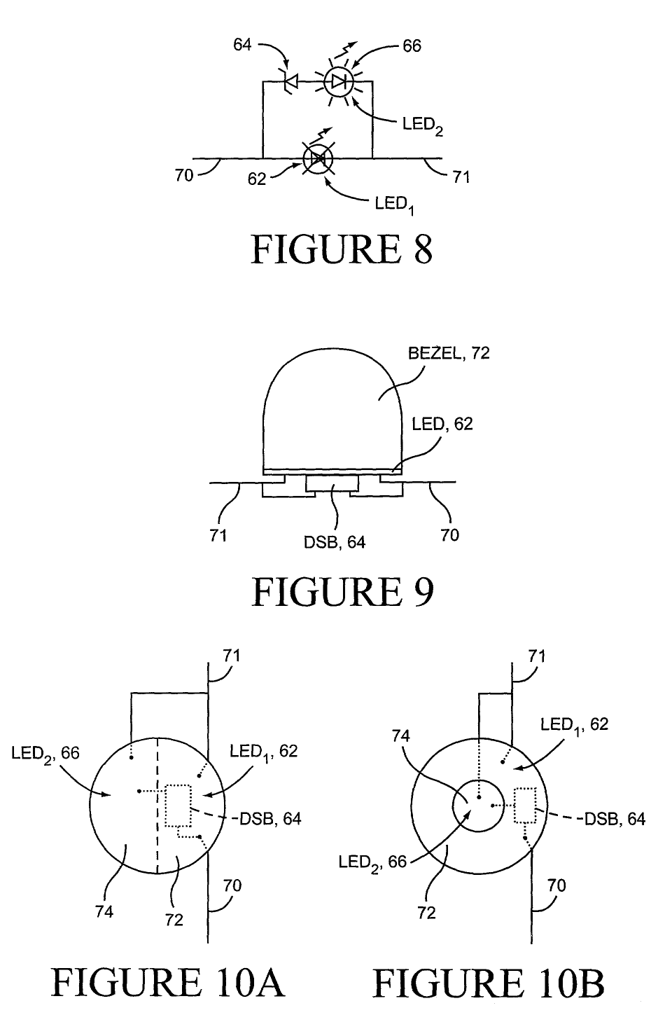

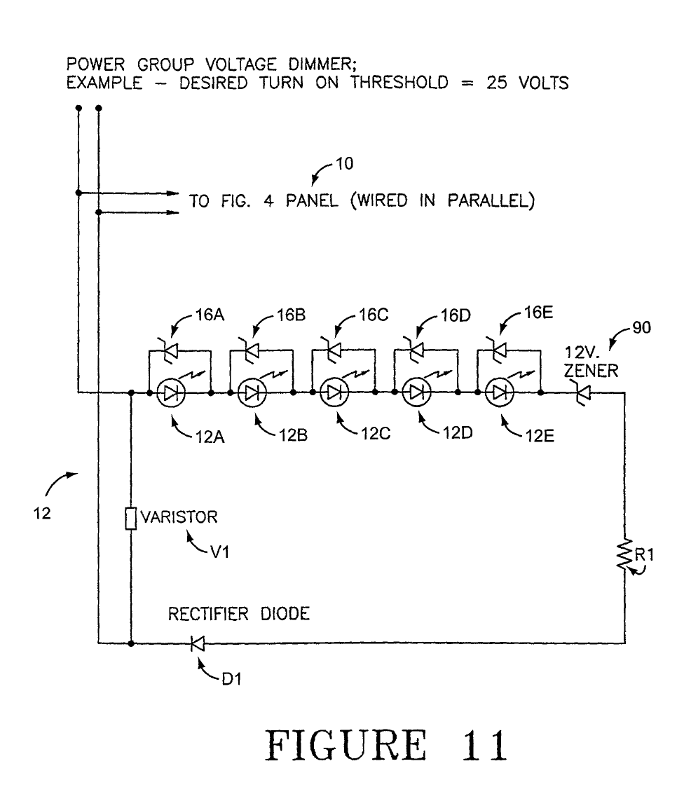

FIG. 8 shows an embodiment of a redundant PS (parallel/series) LED/DSB-LED device. The FIG. 8 arrangement ensures that when a first LED 62 goes out (as shown with the X through the LED element, DSB 64 permits current to flow to a second, closely associated LED 66 (shown as lit) to provide the necessary light for the display. By selecting a DSB 64 and secondary LED 66 appropriately, the voltage drop and turn-on threshold of this redundant architecture is minimally more than in a non-redundant DSB architecture in a long string where only one LED fails. With appropriate balancing of resistances and voltage drops, the secondary LED 66 might be able to be associated with a secondary DSB for double redundancy. Where specifications permit, the secondary LED 66 may be of a different color or intensity from the primary LED 62, so that such a redundant LED arrangement could provide a robust, self-diagnostic illumination system. The closely clustered (or optionally integrated, as shown below in FIG. 10) arrangement of FIG. 8 may be selectively used in special circuits where redundancy is vital.

FIG. 9 is a side elevation cross-sectional view of an integrated DSB/LED device 62, 64 having an optional bezel 72 mounted thereon. This device is an integrated implementation of the DSB/LED arrangement of the inventive system. FIG. 9 shows an LED 62 with a bezel 72 covering or secured to the LED. Co-located with the LED is a DSB 64 on the bottom (back) side of the LED 62. Optionally, the DSB can be located alongside the LED, coplanar with the LED, or in any other suitable configuration. The inventive integrated DSB/LED of FIG. 9, as a device is useful in any application calling for LEDs. However, upon failure of the LED 62, the DSB 64 passes current and the failed LED does not cause any further problems to the circuit, such as the remaining LEDs not lighting. Note the integrated device of FIG. 9 preferably has only one pair of leads, 70, 71, so the wiring into a conventional circuit is straightforward.

FIGS. 10A and 10B implement the inventive circuit of FIG. 8 in an integrated DSB/LED device. FIG. 10A shows a DSB/LED device wherein one side of the device houses the primary LED 62 and its associated DSB 64 in the configuration of FIG. 9, and the second side houses the secondary LED 66. The DSB 64 is shown here on the side of the primary LED 62, though it could be located anywhere on the device, or along side the device as in FIGS. 2, and 4-8. In FIGS. 10A and 10B, the bezel, if present, is preferably a single, monolithic bezel, with the two LEDs being the same color. FIG. 10A shows an alternative design in which the LEDs 62 and 66 are different color. Alternatively, the dashed line indicates a bifurcated bezel with one half 72 being one color and 74 being another color could be used. The color change would alert the viewer to the failed condition of LED 62.

FIG. 10B shows an annulus/core arrangement wherein LED 66 is located centrally of the LED 62. Alternately, the bezel could have an annulus 74 of one color and a core 72 of another color. By appropriately selecting the LEDs or bezel colors, the light emitted by the two LEDs can vary in color or intensity. FIG. 10B is similar to FIG. 10A, with the secondary LED being located within the annulus of the primary LED, or vice versa. FIG. 10B represents a possible embodiment of the invention where the design of the bezel (or overlying, spaced filter, see FIG. 7C) can be used to control a desired change in light seen upon failure of the primary LED.

Alternatively, the two LEDs 62 and 66 in FIGS. 10A and 10B could be on different strings, for simultaneous or sequential on-off illumination, potentially useful in signage, warning devices, e. g., sequential Red/Amber flashing LED point sources. The dual bezel devices of FIGS. 10A and 10B can easily be accommodated in a circuit using the integrated device approach of FIG. 9, or optionally the redundant device architecture of FIG. 8. These examples show the versatility and commercially interesting uses of the inventive circuit and integrated devices.

FIG. 11 illustrates the balancing of turn-on threshold for two strings of differing length, as in LED/DSB strings used in two different, associated displays or two strings in a single display. The upper circuit is a repeat of the circuit of FIG. 4, and in order to not unduly lengthen this description, that disclosure is incorporated by reference here. That circuit was shown by way of example as a 10-LED/DSB string, each having a turn on threshold voltage of approximately 2.5 V for a string total of 25 V. The lower half of FIG. 11 is equivalent to the inner string 12 of FIG. 5, but for a smaller display having only a 5 LED/DSB string, 12A - 12 E for the LEDs, and 16A-16E for the DSBs. The varistor V₁, rectifier diode D₁ and resistor(s) R₁ are as before. The turn-on threshold, i.e., the voltage at which brightness from the display is first discernable, would only be 12.5 V, which does not match the larger display. To avoid having to have each panel have an individual dimmer, and to permit providing a single master dimmer for the cockpit or lighting group (a plurality of displays), the shorter string can be provided with a series-wired Zener or TVS 90 as shown. In this example, the Zener 90 is a 12 V device, so that the total for the lower display is 24.5 V, and a single dimmer can serve both. This design can be a applied to other panels within a cockpit or lighting group by appropriate selection of the voltage balancing element. The voltage rating of the Zener 90 may be selected to be larger or smaller depending on the number of series wired LEDs in the several panels. Where the maximum string used is 10 LEDs (being adequate for the illumination required for the displays), yet the customer requirements are for a higher turn-on voltage, the turn-on voltage can be likewise increased by the same principles.

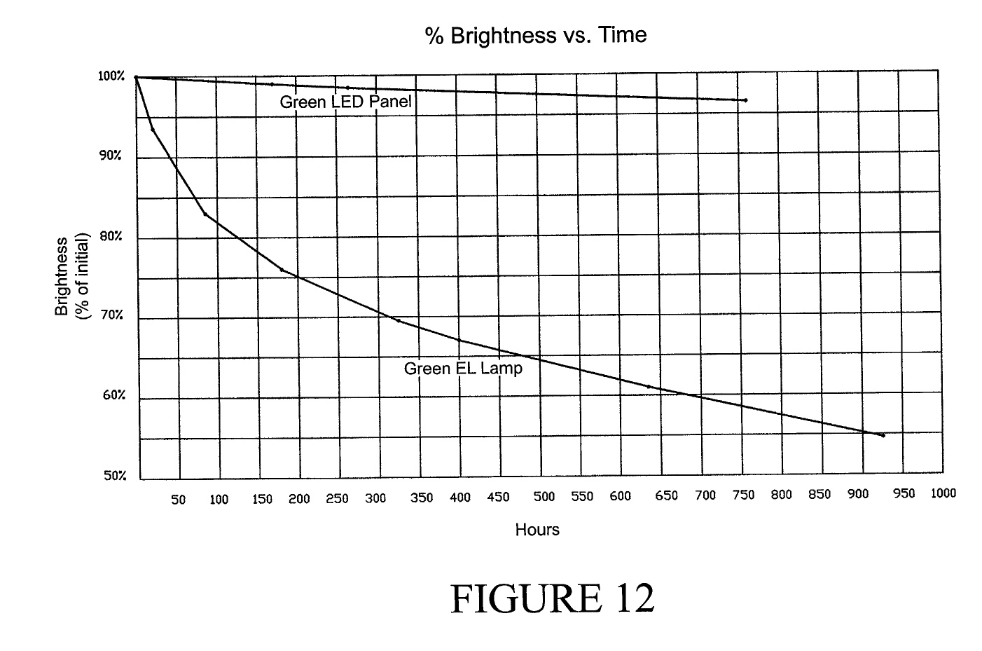

FIG. 12 is a graph of % Brightness vs Time in which the traces show the significantly longer life of a green LED panel (using Toyoda Gosei E1S02-3G LEDs) as compared to a standard green EL panel. As shown, the EL illumination shows a precipitous drop in the first 50-300 hours, and continues to decline over time, while the LED panel is essentially straight line at a very shallow slope. Longer testing using white LEDs has shown that the LED is still at 93% brightness after 9000 hours, while a comparable green EL is at its half-life (time to 50% brightness) at about 1250 hours. This graph illustrates the significantly improved service life of the LEDs as compared to EL lamps.

The inventive use of a single Zener Diode or similar DSB device for one LED, as compared to use of the TVS with anti-parallel LED pairs, results in only a single LED failing to light upon the failure of an LED, instead of two or more LEDs not lighting with the failure of one LED. However, the invention contemplates the use of a DSB device with at least one LED, that is, the DSB device may be paired in parallel with one or more LEDs, depending on the need to insure relatively no blackouts. Placed closely adjacent to each other, pairs of DSB/LED units of the invention in such dual light arrangements would provide redundant illumination in the event of failure of one of the pair. This arrangement is particularly useful for critical displays, such as safety or warning signs, for example: radiation or other dangerous condition warning or failure alert displays, vehicular stop or back up lights, fire or other disaster exit signage, and the like.

### Industrial Applicability

It is clear that the circuits and system of the invention will have wide industrial applicability, not only to panel illumination, but also to other illumination systems, such as general LED arrays.

Because LEDs themselves are very reliable, and with this invention the entire LED-circuit or system becomes less subject to blackout, the inventive display light sources can be used in Aerospace cockpit and cabin lighting where power is 115 VAC/400 hz (FIGS. 6A-6B and 7A-7C demonstrate such an arrangement). Higher or lower frequencies may also be utilized without additional modifications. If the circuit requires higher or lower voltages, the inventive circuit can accommodate them by simply changing the resistor values, the number of series components, the turn-on threshold levels, or some combination thereof. Moreover, in helicopter, tank, or other military applications where rugged display light sources are imperative, the invention will be ideal. An important possible use of the invention will be in dashboard displays for automobiles, as well as the taillights of automobiles, the Center High Mounted Safety Lights (CHMSL or 3 ^{rd} Brake Lights), or any similar application in commercial vehicles. Further application can be found in commercial lighting applications or as replacements for components using electroluminescent lamps. In any application where touch panels are used, the inventive system allows the use of LEDs, which avoids problems of “touch” components becoming too hot.

An important industrial use will be in any critical application that self-diagnosis is important or where the ability to quickly diagnose LED problems is important. The inventive system allows only one or a small group of LEDs to fail to light rather than a whole circuit when one LED fails. This makes diagnosis simple and reduces the need for redundancy.

The invention could also be used in situations where redundancy is useful. In emergency lighting, like signs or pathway illumination, the invention could ensure illumination in the event of a failed light element. Moreover, in aviation, spacecraft, medical devices, or automobile use, emergency systems could use redundant systems like the invention. In an automobile, if there is a failure in the braking system but the dash light bulb has failed, the driver would not have a way of knowing of the impending danger. With the invention, the lighting for the dash display would not fail with the failure of a single bulb. Moreover, if used in the brake lights themselves, the DSB/LED combination would allow large LED arrays to provide sufficient light and continue to work in the event of an LED failure.

For instrument lighting, circuits can employ paired DSB/LED elements or the integrated device of FIG. 9. As seen in FIG. 6, the instrument wiring on FIG. 6B is straightforward, with several LEDs and parallel DSBs. The front portion of the instrument is shown above, in FIG. 6A. The end resulting instruments look identical to typical instruments but as described above, they are more rugged and are self-diagnostic. Merely by removing panel 6A, the burned out LED is visible by contrast with those remaining lit.

The inventive bypass architectures increase the reliability and ruggedness of any circuit and, as such, involve only minor modifications, if any, of the circuits and/or LED layouts for panel illumination. Any present commercial application that employs LEDs can use the inventive LED/DSB integrated devices of FIG. 9 with essentially no modifications.

Likewise, the inventive redundant LED/DSB/LED architecture depicted in FIGS. 8, 10A, and 10B may be used in most circuits with appropriate circuit modifications, as can be readily understood and accomplished by one of ordinary skill in the art, considering the voltage increase upon current flow through the secondary DSB/LED circuit branch upon failure of the primary LED. For example, in the case of a circuit employing 20 LED/DSBs where at least one is a redundant LED/DSB/LED device of FIGS. 8, 10A or 10B and where there is a concern regarding increase in total circuit voltage drop if the primary LED of the redundant device goes out, one other LED/DSB may be eliminated to prevent excess voltage drop in the circuit. That is, such a circuit could use 19 LED/DSBs, one of which is a redundant. Or, the supply voltage can be adjusted or selected to ensure sufficient voltage in the case of one or more LED burn-outs. The redundant, dual type LED/DSB/LED of FIG. 8 typically will be reserved for illuminating a critical actuator in a panel, such as an arming device, safety switch, emergency shut-down switch, reserve power cut-in switch, and the like.

The potential for using the integrated device of FIG. 9 is particularly attractive in many applications where the cost of changing the entire circuitry is prohibitive, but the cost of replacing just the LEDs is considered part of the normal maintenance costs. Thus, the integrated device of FIG. 9 permits LED circuits of the type of FIGS. 1 and 3 to be retrofitted with the inventive LED/DSB architecture in appropriately powered circuits. As any LED-employing circuit could use the inventive integrated DSB/LED devices of FIG. 9, the application of such integrated devices is possible in all industries, especially those requiring extreme reliability, like military, space, medical, safety, nuclear power generation, and other such applications.

It should also be understood that the DSB bypass burnout protection architecture of this invention is applicable to incandescent bulb strings, where the DSB voltage and power rating is selected to be matched to the bulb. Typically the TVS and Zeners will be the DSB of choice for use in incandescent string panel illumination. Thus, the invention includes use of Incandescent/DSB pairs in series or series-parallel lighting circuits and in integrated Incandescent/DSB devices in appropriate situations, such as low shock or low vibration environments.

It should be understood that one skilled in the art could make use of DSB devices within the scope of this invention without departing from the spirit thereof. For example, a component could integrate the DSB and LED elements on a single base or in a singe device with a plastic head or bezel covering both, or placing the DSB on the bottom of the LED base to form a single bi-functional integrated unit. It is therefore intended that this invention be defined by the scope of the claims as broadly as the prior art will permit, and in view of the specification, if need be.

1. In an electrical circuit employing at least one LED or incandescent light element for illumination, the improvement comprising connecting at least one DSB element in parallel with said at least one light element so that when said light element fails, said circuit continues to pass current through said DSB to permit at least some remaining circuit components to function.

2. Improved circuit as in claim 1 wherein said DSB element is selected from at least one of an MLV, an MOV, a silicon TVS, and a Zener Diode, and where a Zener Diode is used, it is oriented in polarity opposite to said light element where said light element has a polarity.

3. Improved circuit as in claim 1 wherein said circuit employs a plurality of LEDs.

4. Improved circuit as in claim 2 wherein said circuit employs a plurality of LEDs.

5. Improved circuit as in claim 3 wherein at least some of said LEDs are connected in at least one of series and parallel in at least one branch.

6. Improved circuit as in claim 4 wherein at least some of said LEDs are connected in at least one of series and parallel in at least one branch.

7. Improved circuit as in claim 1 wherein said circuit is powered current selected from alternating, rectified alternating, and direct current.

8. Improved circuit as in claim 2 wherein said circuit is powered current selected from alternating, rectified alternating, and direct current.

9. Improved circuit as in claim 6 wherein said circuit is powered by alternating current, said LEDs are connected in parallel branches with opposed polarity to provide illumination in alternate branches on each half cycle, and at least one DSB element is associated with each branch.

10. In a panel illumination assembly comprising a faceplate and a circuit board disposed spaced below said faceplate, said circuit board having an array of light elements selected from LEDs and incandescent bulbs thereon oriented for illumination of pre-selected areas of said faceplate, the improvement comprising connecting at least one DSB element in parallel with at least one light element so that when said light element fails, said circuit continues to pass current through said DSB to permit other light elements in said circuit to function.

11. Improved panel illumination device as in claim 10 wherein said DSB element is selected from at least one of an MLV, an MOV, a silicon TVS, and a Zener Diode, and where Zener Diodes are used, they are oriented in polarity opposite to the polarity of said light element.

12. Improved panel illumination device as in claim 11 wherein at least some of said light elements are LEDs connected in at least one of series and parallel in at least one branch.

13. Improved panel illumination device as in claim 12 wherein said circuit is powered by current selected from alternating, rectified alternating, and direct current.

14. Improved panel illumination device as in claim 13 wherein said circuit is powered by AC current, and:
a) where said AC current is rectified, said LEDs are connected in each of said at least one branch with the same polarity orientation, and
b) where said AC current is not rectified, said LEDs are connected in parallel branches with said LEDs in alternate branches being oriented in opposed polarity orientation to provide illumination in said alternate branches on each half cycle, and
c) where at least one DSB element is associated with each of said branches.

15. Improved panel illumination device as in claim 10 which includes at least two light element strings of LEDs, wherein a different number of LEDs are distributed in at least one panel, and said string with fewer LEDs includes a DSB device in opposed polarity in series with the LEDs of said string to balance the turn-on threshold voltage of said string having more LEDs for balanced dimming of both strings.

16. Method of maintaining light output of a multi-element light element array illumination device having a lit portion, comprising the steps of:
a) electrically connecting at least one DSB element in parallel with a preselected group of light elements of said illumination device;
b) supplying current to said light element illumination device so that said light elements are lit;
c) continuing to supply current to said light element illumination device after at least one light element fails, by passing current through said DSB element to permit other light elements of said device to remain lit;
d) thereby maintaining a substantial area of said device illuminated in proportion to the number of remaining operable light elements to the total light elements of said array.

17. Method as in claim 16 that includes the added step of diagnosing which of the light elements in said array has failed by associating a DSB element in parallel with a at least one light element in a relatively close grouping.

18. Method as in claim 16 wherein said current is selected from alternating, rectified alternating, and direct current.

19. Method as in claim 18 wherein said DSB element is selected from at least one of an MLV, an MOV, a silicon TVS, and a Zener Diode, and where a Zener Diode is used, it is oriented in polarity opposite to said light element, where said light element has a polarity.

20. Method as in claim 18 wherein said step of electrically connecting at least one DSB to a preselected group of light elements includes pairing a DSB with an LED.

21. Method as in claim 20 that includes the added step of providing redundancy by adding a secondary LED in series with said DSB element, thereby continuing to provide near full illumination upon the failure of the bypassed primary LED.

22. Method as in claim 20 wherein said step of pairing a DSB with an LED comprises providing said paired DSB and LED as an integrated device.

23. An integrated illumination device comprising a DSB element in parallel with at least one LED.

24. An integrated illumination device as in claim 23 wherein said DSB element is paired with a single LED.

25. An integrated illumination device as in claim 24 wherein said paired DSB and LED are integrated in a single device.

26. An integrated illumination device as in claim 23 comprising a secondary LED electrically connected in series with said DSB and mounted in association with said DSB.

27. An integrated illumination device as in claim 23 wherein said DSB element is selected from at least one of an MLV, an MOV, a silicon TVS, and a Zener Diode, and where a Zener Diode is used, it is oriented in polarity opposite to said LED.
